(19) United States
(12) Patent Application Publication
(10) Pub. No.: US 2004/0209030 A1
(43) Pub. Date: Oct. 21, 2004

(54) Glass brick

(76) Inventor: Enrico Basso, Parma (IT)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/482,155

(22) PCT Filed: May 28, 2002
(86) PCT No.: PCT/IT02/00342

(30) Foreign Application Priority Data
Jun. 20, 2001 (IT) PR2001U000004

(51) Int. Cl. B32B 3/10

(52) U.S. Cl. 428/44

(57) ABSTRACT

A glass brick of the type comprising two mutually parallel exterior surfaces (2), connected by interior walls (3) that extend substantially perpendicular from the exterior surfaces themselves is characterised in that the average distance (4) between the edge or outer perimeter of the exterior surfaces (2) and the interior walls (3) connecting the surfaces themselves is at least 6 mm and preferably between 6 and 20 mm.

### TECHNICAL FIELD AND BACKGROUND ART

The present invention relates to a glass brick.

Glass bricks are used in the construction industry every time it is necessary to allow light to pass through surfaces without excluding high mechanical resistance conditions and a particular aesthetic value.

Glass bricks are known, obtained by means of two mutually parallel surfaces constituting the exterior surfaces of the brick (generally having a square or rectangular geometric figure) able to form the vertical surface of the finished walls.

The exterior surfaces of the brick are mutually connected by glass surfaces positioned perpendicularly to the first surfaces along the peripheral edges, thereby determining the thickness of the brick and its bearing and anchoring side.

The finished object is a regular parallelepiped with rectangular bearing bases and square or rectangular vertical surfaces.

The brick is obtained by heat sealing two half bricks, constituted by a vertical surface and by one half of the bearing surface

The heat sealing operation is performed along the axis positioned on the centreline of the brick thickness and parallel to the exterior surfaces of the brick itself.

Use of prior art bricks has some limitations and drawbacks involving both the laying procedures and the aesthetic aspect of the finished product.

The laying limitations described below strongly condition aesthetics and pertain both to traditional laying with mortar as a binder, and dry systems assembled on site or pre-assembled.

The construction of vertical/horizontal surfaces with glass bricks imposes the interposition of mortar between a brick and another, to serve as a mechanical binder. The visible thickness on the exterior surfaces of the mortar may not be reduced below certain safety limits, normally 10-20 mm.

The visible thickness of the exterior surface determines the variation of the resistant area of the mortar placed in the thickness of the brick.

As the visible thickness of the mortar increases, however, the glass surface continuity effect decreases.

An additional drawback is due to the fact that the interstice areas between bricks, filled with mortar, are areas of high heat transmittance, i.e. the transmission of heat or cold through them is facilitated, whilst the area where glass is present has insulating characteristics. Therefore, wide interstice areas worsen the thermal insulation of the wall or of the floor built with glass bricks.

Installation with dry systems imposes, due to the type of section of the glass brick, that all assembly structures contain the glass brick superposing to the exterior surfaces, limiting the transparent surface of the glass brick and causing aesthetic harm.

### DISCLOSURE OF INVENTION

An aim of the present invention is to make available a glass brick that allows a proper and stable positioning even without evident mortar junction lines, or its laying with the use of dry systems contained within the brick thickness.

A further aim is to improve the thermal insulation of the wall or of the floor built with said glass bricks.

Said aims are fully achieved by the glass brick of the invention, which is characterised by the content of the claims set out below and in particular in that the average distance between the edge or outer perimeter of the visible exterior surfaces and the walls connecting the surfaces themselves is at least 6 mm, and preferably ranges between 6 mm and 20 mm.

### BRIEF DESCRIPTION OF DRAWINGS

This characteristic will become more readily apparent from the description that follows of a preferred embodiment illustrated, purely by way of non limiting example, in the accompanying drawing tables, in which:

FIG. 1 shows a front view of a glass brick according to the present invention;

FIG. 2 shows a lateral view of a brick of FIG. 1, partially sectioned.

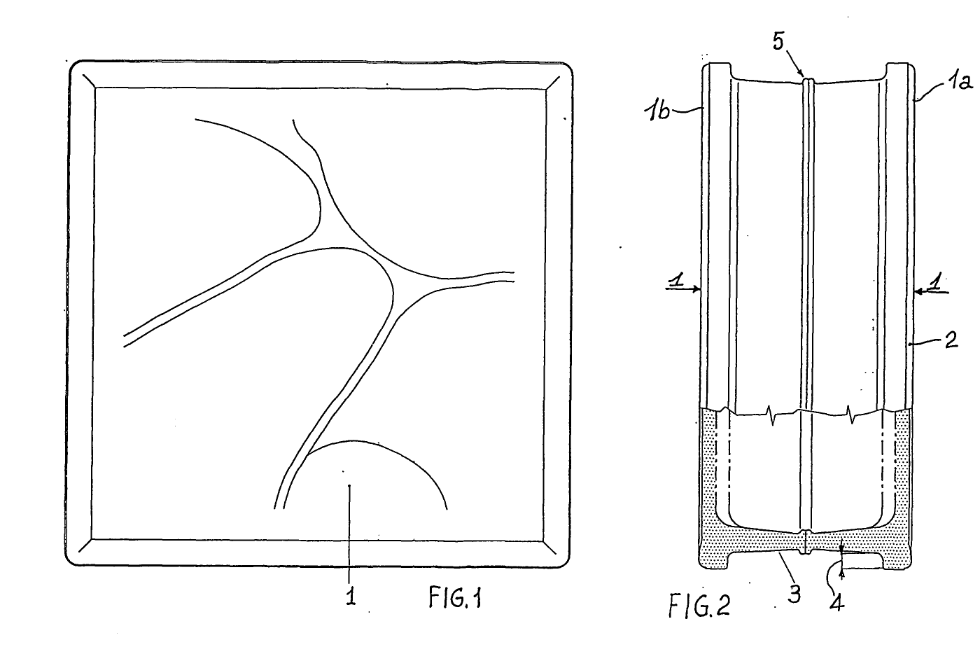

### BEST MODE FOR CARRYING OUT THE INVENTION

With reference to the figures, the number 1 globally indicates a glass brick used in the construction industry as a structural and decorative element, formed by the union of two mutually joined half-bricks 1a and 1b.

Said brick comprises two mutually parallel exterior surfaces 2, connected by interior walls 3 that extend substantially perpendicular from the exterior surfaces 2.

The exterior surfaces 2 have preferably quadrangular shape and the average distance between the edge or outer perimeter of the surfaces themselves and the connecting walls 3, indicated as 4 in FIG. 2, is originally at least 6 mm and preferably between 6 and 20 mm.

This characteristic allows to reduce to no more than 2 mm the cement junction lines between adjacent bricks on the exterior wall without altering the interior surface of the cement between adjacent bricks; along the outer edge of the brick, between the two exterior surfaces 2, is generated a housing 5 that is deeper than in traditional bricks. The connecting cement between adjacent bricks is inserted in the aforesaid housing 5 between the exterior surfaces 2 and the interior walls 3 in such a quantity as to assure the proper and stable positioning of the bricks.

The housing between the exterior surfaces 2 and the interior walls 3 also allows to house such a dry laying structure as to maintain unaltered the visible surface of the glass brick, increasing its aesthetic effect and stability.

Consequently, adjacent bricks be they installed with mortar or dry structure can, when viewed, appear to be in direct contact, whilst assuring in any case the stability of the structure.

1. Glass brick of the type comprising two mutually parallel exterior surfaces (2), connected by interior walls (3) that extend substantially perpendicular from the exterior surfaces themselves, characterised in that the average distance (4) between the edge or outer perimeter of the exterior surfaces (2) and the interior walls (3) connecting the surfaces themselves is at least 6 mm.

2. Glass brick as claimed in claim 1, wherein said average distance (4) is between 6 and 20 mm.

3. Glass brick as claimed in claim 1, wherein the average distance (4) is such as to define a housing (5) for the placement of mortar or a dry laying structure so as to reduce to no more than 2 mm the cement junction lines between adjacent bricks or the visible part of the dry laying structure.

4. Wall or floor, characterised in that it comprises a plurality of glass bricks as claimed in any of the previous claims.
